(19) United States
(12) Patent Application Publication
(10) Pub. No.: US 2008/0265627 A1
(43) Pub. Date: Oct. 30, 2008

(54) Securing Device

(75) Inventors: Helmut Bodirsky, Neu-Ulm (DE); Bernhard Garhofer, Ulm (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/064,689

(22) PCT Filed: Aug. 1, 2006
(86) PCT No.: PCT/EP2006/007589

§ 371 Date: Jun. 25, 2008

(30) Foreign Application Priority Data
Aug. 26, 2005 (DE) 10 2005 040 479.0

(51) Int. Cl. B60R 27/00

(52) U.S. Cl. 296/210

(57) ABSTRACT

A device for securing at least one hand rail on a vehicle roof has a securing rail, on which the hand rail can be secured, and paneling. In order to provide a device by which securing of the hand rail is simplified, the paneling has an installation access gap that runs along the securing rail and is closed by a gap cover.

### BACKGROUND AND SUMMARY OF THE INVENTION

This invention relates to a device for securing at least one hand rail on a vehicle roof, with a securing rail on which the hand rail can be fastened, and with paneling.

European patent application EP 0 768 416 A1 discloses a hand rail which is secured on a profiled rail which is arranged at a distance from and approximately parallel to the ceiling and has a T-shaped groove at least on the side facing away from the ceiling. The hand rail is secured on the profiled rail by means of a sliding component arranged in the groove. German laid-open specification document DE 100 51 967 A1 discloses an arrangement for the rotationally secure mounting of hand rail systems. German utility model DE 299 13 289 U1 discloses a hand rail system for public transportation, in which extruded profiles made of aluminum are provided as the basic element. European patent specification EP 0 352 216 B1 discloses an arrangement for securing a hand rail.

It is the object of the invention to provide a securing device by which the securing of the hand rail is simplified.

This object is achieved, in a device for securing at least one hand rail on a vehicle roof, with a securing rail on which the hand rail can be secured, and with paneling, by providing the paneling with an installation access gap, which runs along the securing rail and is closed by a gap-covering means. In conventional securing devices, the rail is covered by the paneling. The paneling has to be cut open at the securing point in order to install the hand rail. The installation access gap according to the invention considerably simplifies access to the securing rail. The gap is covered before and after installation of the hand rail by the gap-covering means according to the invention. During installation of the hand rail, the gap-covering means can be removed at the particular securing point in a simple manner, for example by being pulled out, bent over, and/or cut out.

In a preferred embodiment of the device, the gap-covering means has a covering lip which bridges the installation access gap. It is also possible to close the installation access gap by two covering lips butting against each other. However, this has the disadvantage that the abutting edge is visible. The installation access gap can be completely closed by the one sealing lip.

In a further preferred embodiment of the device, the covering lip is arranged on that side of the paneling which faces away from the vehicle interior. As a result, the installation access gap is neatly closed without the optical impression of the paneling being impaired.

In a further preferred embodiment of the device, the covering lip is formed from a flexible plastics material. For example, the covering lip is formed from ethylene-propylene-diene rubber.

In a further preferred embodiment of the device, the covering lip emerges from a clamping profile. The clamping profile permits simple installation of the covering lip.

In a further preferred embodiment of the device, the clamping profile and the covering lip are formed from a coextrusion profile. The production costs are kept low as a result.

In a further preferred embodiment of the device, the clamping profile is clamped on a limb of an angle profile. The angle profile is preferably formed from steel plate.

In a further preferred embodiment of the device, the other limb of the angle profile is secured on the securing rail. The other limb of the angle profile can be connected to the securing rail, for example by a cohesive material joint, by means of welding, soldering or adhesive bonding. However, the other limb of the angle profile may also be secured on the securing rail with the aid of securing elements, such as rivets or screws.

Further advantages, features and details of the invention emerge from the description below in which an exemplary embodiment is described in detail with reference to the drawings. The features mentioned in the claims and in the description may be essential to the invention individually by themselves or in any desired combination.

### BRIEF DESCRIPTION OF THE DRAWINGS

FIG. 1 shows the view of a section through a securing device according to the invention;

FIG. 2 shows a securing device from FIG. 1 on its own in cross section; and

FIG. 3 shows a covering means from FIG. 1 on its own in cross section.

### DETAILED DESCRIPTION OF THE INVENTION

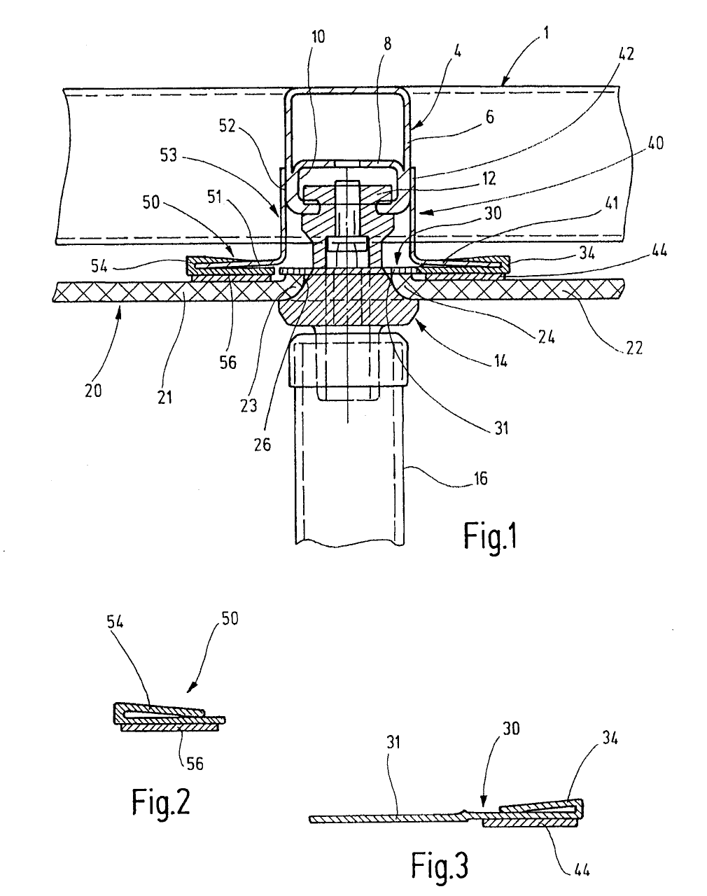

A supporting structure 1 of a vehicle roof, on which structure a securing rail 4 is secured, is indicated in FIG. 1. The securing rail 4 is illustrated in cross section and comprises a hollow profile 6 which is combined with a C profile 8. The C profile 8 comprises a T groove 10 in which a head 12 of a securing element 14 is secured. The securing element 14 serves to secure one end of a hand rail 16 on the securing rail 4 in a known manner.

The supporting structure 1 of the vehicle roof is covered toward a vehicle interior by a paneling which comprises a plurality of paneling parts 21, 22. The paneling parts 21, 22 each have an upwardly curved edge region 23, 24 in the region of and along the securing rail 4. An installation access gap 26 which runs along the securing rail 4 is recessed between the edge regions 23, 24 of the paneling parts 21, 22. The installation access gap 26 makes it possible in a simple manner to insert the securing element 14 into the T groove 10 from the vehicle interior.

The installation access gap 26 is closed by a covering means 30. The covering means 30 comprises a covering lip 31 which emerges from a clamping profile 34. The covering lip 31 is formed from a flexible plastics material and completely covers the installation access gap 26. The covering lip 31 is somewhat longer than the installation access gap 26 and rests on the edge regions 23, 24 of the paneling parts 21, 22. The clamping profile 34 is pushed onto a limb 41 of an angle profile 40, the other limb 42 of which is secured on the securing rail 4. A hooked tape 44 is fitted, for example adhesively bonded, to the lower side of the clamping profile 34. The hooked tape 44 serves to secure the paneling part 22 on the clamping profile 34, for example with the aid of a touch and close tape which interacts with the hooked tape 44 and is secured on the paneling part 22.

The paneling part 21 is secured with the aid of a securing means 50 on one limb 51 of an angle profile 53, the other limb 52 of which is secured on the securing rail 4. The securing means 50 comprises a clamping profile 54 which is pushed onto the limb 51 of the angle profile 53. A hooked tape 56 is secured on the lower side of the clamping profile 54. The hooked tape 56 serves to secure the paneling part 21 on the angle profile 53 with the aid of a suitable touch and close tape.

FIG. 2 illustrates the fastening means 50 on its own in cross section.

FIG. 3 illustrates the covering means 30 on its own in cross section.

FIG. 1 illustrates the covering element 30 in a state in which the covering lip 31 completely covers the installation access gap 26. The securing rail 4 is concealed in this state, and it is therefore not visible from the vehicle interior. Before the securing element 14 is fitted on the securing rail 4, the covering lip 31 can be pulled out through the installation access gap 26 and machined, for example with the aid of a pair of punching tongues. Furthermore, in the pulled-out state of the covering lip 31, securing bearings or spacer components can be fitted on the securing rail 4. After machining and/or trimming of the covering lip 31, the latter is pressed again behind the paneling parts 21, 22 in order to conceal the securing rail 4. It is also possible to press away the covering lip 31 by means of the securing element 14 during the fitting thereof. Machining of the covering lip 31 can then be omitted.

1-8. (canceled)

9. A device for securing at least one hand rail on a vehicle roof, comprising:
a securing rail on which the hand rail is securable, and
paneling having an installation access gap that runs along the securing rail and is closed by a gap cover.

10. The device as claimed in claim 9, wherein the gap cover has a covering lip that bridges the installation access gap.

11. The device as claimed in claim 10, wherein the covering lip is arranged on that side of the paneling facing away from a vehicle interior.

12. The device as claimed in claim 10, wherein the covering lip is formed from a flexible plastics material.

13. The device as claimed in claim 10, wherein the covering lip emerges from a clamping profile.

14. The device as claimed in claim 13, wherein the clamping profile and the covering lip are formed from a coextrusion profile.

15. The device as claimed in claim 13, wherein the clamping profile is clamped on a limb of an angle profile.

16. The device as claimed in claim 15, wherein another limb of the angle profile is secured on the securing rail.

17. The device as claimed in claim 11, wherein the covering lip is formed from a flexible plastics material.

18. The device as claimed in claim 11, wherein the covering lip emerges from a clamping profile.

19. The device as claimed in claim 12, wherein the covering lip emerges from a clamping profile.

20. The device as claimed in claim 18, wherein the clamping profile and the covering lip are formed from a coextrusion profile.

21. The device as claimed in claim 19, wherein the clamping profile and the covering lip are formed from a coextrusion profile.

22. The device as claimed in claim 14, wherein the clamping profile is clamped on a limb of an angle profile.

23. The device as claimed in claim 18, wherein the clamping profile is clamped on a limb of an angle profile.

24. The device as claimed in claim 19, wherein the clamping profile is clamped on a limb of an angle profile.

25. The device as claimed in claim 22, wherein another limb of the angle profile is secured on the securing rail.

26. The device as claimed in claim 23, wherein another limb of the angle profile is secured on the securing rail.

27. The device as claimed in claim 24, wherein another limb of the angle profile is secured on the securing rail.
